(19) United States
(12) Patent Application Publication
(10) Pub. No.: US 2012/0173863 A1
(43) Pub. Date: Jul. 5, 2012

(54) ELECTRONIC DEVICE

(75) Inventor: XING-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/213,064

(22) Filed: Aug. 18, 2011

(30) Foreign Application Priority Data
Dec. 29, 2010 (CN) 201010612549.8

(51) Int. Cl. G06F 9/06; G06F 1/26

(52) U.S. Cl. 713/100

(57) ABSTRACT

An electronic device includes a power source, a processor, a switching module, and an interface module. The power source provides operating voltage. The processor can switch between a first mode and a second mode. The switching module connects between the processor and the interface module. The interface module is used for exchanging data with an external device. When the processor is in the first mode, the switching module turns off. The power source stops providing operating voltage to the interface module.

### BACKGROUND

1. Technical Field

The present disclosure relates to electronic devices, and particularly to an electronic device with an interface module.

2. Description of Related Art

Many electronic devices can exchange data with an external device using a wireless or a wired connection. In one such wired connection, the electronic device may be provided with a USB port to be connected to the external device. However even when the USB port is not in use, the electronic device still provides operating voltage to the USB port, thus energy is wasted.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of an embodiment of the electronic device of FIG. 1 in accordance with one embodiment.

### DETAILED DESCRIPTION

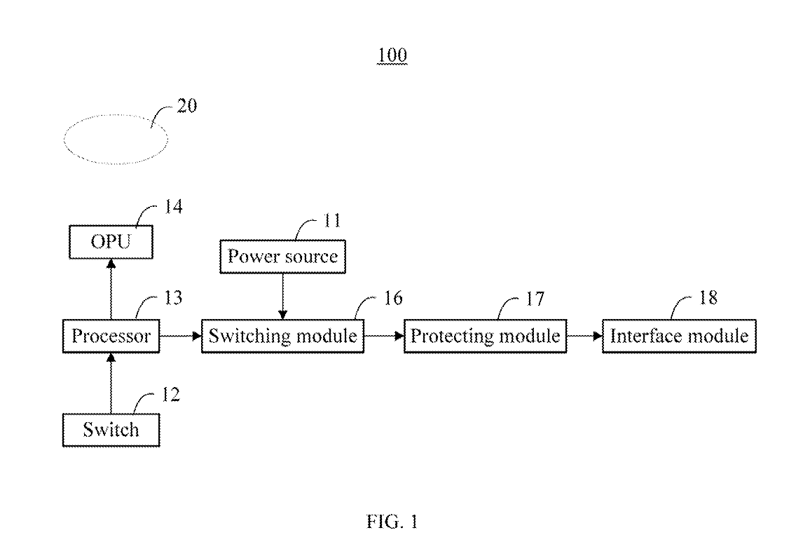

Referring to FIG. 1, an electronic device 100 can exchange data with other external devices. The electronic device 100 includes a power source 11, a switch 12, a processor 13, an optical pickup head (OPU) 14, a switching module 16, a protecting module 17, an interface module 18, and an optical disk 20. In the embodiment, the electronic device 100 is a portable disk player. In other embodiment, the electronic device 100 can be a computer, a video player, and etc.

The power source 11 is used for providing an operating voltage.

The switch 12 is used for switching the processor 13 between a first mode and a second mode. When the switch 12 is turned off, the processor 13 switches to the first mode, and generates a first control signal and a driving signal. When the switch 12 is turned on, the processor 13 switches to the second mode, and generates a second control signal and stop generating the driving signal. In the embodiment, the first control signal is a low level signal, and the second control signal and the driving signal are high level signals.

The OPU 14 is used for emitting laser beams onto the optical disk 20 in response to the driving signal and receiving reflected laser beams from the optical disk 20 to reproduce information from the optical disk 20 or record information to the optical disk 20.

The switching module 16 is used for controlling an electrical connection between the power source 11 and the protecting module 17. In response to the first control signal, the switching module 16 is turned off. The switching module 16 cuts off the electrical connection between the power source 11 and the protecting module 17 and stops providing operating voltage to the protecting module 17. In response to the second control signal, the switching module 16 is turned on. The power source 11 connects with the protecting module 17 and provides operating voltage to the protecting module 17.

The interface module 18 is used for exchanging data with an external device. In the embodiment, the interface module 18 is a USB port.

The protecting module 17 is used for detecting whether a current flowing through the protecting module 17 is at least a predetermined value, and controlling the electrical connection between the switching module 16 and the interface module 18 based on the result. If the current is at least the predetermined value, the protecting module 17 establishes an electrical connection between the switching module 16 and the interface module 18. If the current is less than the predetermined value, the protecting module 17 cuts off the electrical connection between the switching module 16 and the interface module 18. In the embodiment, the predetermined value is 500 mA.

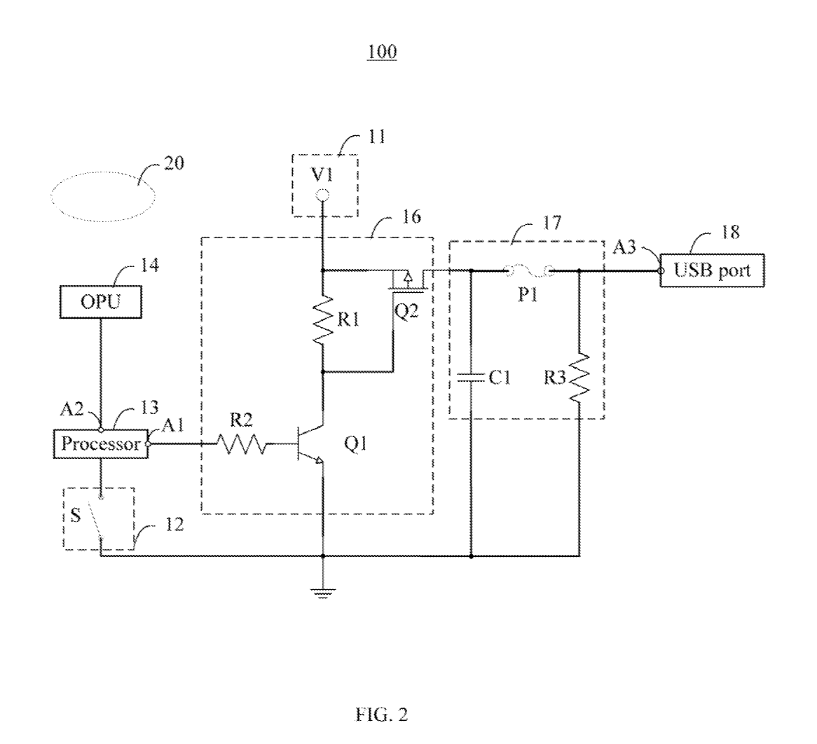

Referring to FIG. 2, the power source 11 includes a voltage source V1. The switch 12 is electrically connected between the processor 13 and ground.

The processor 13 includes a first pin A1 and a second pin A2. The first pin A1 is electrically connected to the switching module 16. The second pin A2 is electrically connected to the OPU 14.

The switching module 16 includes a first resistor R1, a second resistor R2, a first transistor Q1, and a second transistor Q2. The first resistor R1 is electrically connected between a collector of the first transistor Q1 and voltage source V1. The second resistor R2 is electrically connected between the first pin A1 and a base of the first transistor Q1. An emitter of the first transistor Q1 is grounded. A source of the second transistor Q2 is electrically connected to the voltage source V1. A drain of the second transistor Q2 is electrically connected to the protecting module 17. A gate of the second transistor Q2 is electrically connected to the collector of the first transistor Q1. In the embodiment, the first transistor Q1 is an NPN type bipolar junction transistor. The second transistor Q2 is a p-channel enhancement type metal oxide semiconductor field effect transistor.

The protecting module 17 includes a fuse P1, a capacitor C1, and a third resistor R3. The fuse P1 is electrically connected between the drain of the transistor Q2 and the interface module 18. The capacitor C1 is electrically connected between the drain of the transistor Q2 and ground. The third resistor R3 is electrically connected between an end of fuse P1 which is electrically connected with the interface module 18 and ground. In the embodiment, the fuse P1 is a recoverable fuse. When the current is at least 500 mA, the fuse P1 is switch to a high-impedance status. When the current is less than 500 mA, the fuse P1 is switch to a low resistance status.

The interface module 18 includes a third pin A3. The third pin A3 is electrically connected to the drain of the second transistor Q2 through the fuse P1. In the embodiment, the interface module 18 is a USB port.

When the switch S is turned off, the processor 13 generates the first control signal through the first pin A1 and the driving signal through the second pin A2. The OPU 14 is powered on based on the driving signal. The difference in voltage between the base of the first transistor Q1 and the emitter of the first transistor Q1 is less than 0.7V. The gate of the second transistor Q2 is pushed to voltage source V1. The difference in voltage between the gate of the second transistor Q2 and the source of the second transistor Q2 is equal to 0V. The second transistor Q2 is turned off. The third pin A3 is at a low level. As a result, the electronic device 100 can not exchange data with the external device.

When the switch S is turned on, the processor 13 generates the second control signal through the first pin A1. The difference in voltage between the base of the first transistor Q1 and the emitter of the first transistor Q1 is more than 0.7V. The transistor Q1 is turned on. The gate of the second transistor Q2 is pulled to ground. The difference between the gate of the second transistor Q2 and the source of the transistor Q2 is less than the 0V. The second transistor Q2 is turned on. The voltage source V1 supply is operating voltage to the third pin A3 through the fuse P. The third pin A3 is at a high level. Consequently, the electronic device 100 can exchange data with the external device.

When the processor 13 is in the second mode, if the voltage of the voltage source V1 rises to a high level, and the current flowing through the fuse P is at least 500 mA, the fuse P then switches to a high-impedance status, and the third pin A3 is at a low level. Thus, the electronic device 100 cannot exchange data with the external device.

As described, when there is no need to power on the interface module 18, the power source 11 will stop supplying operating voltage. Therefore, energy can be saved.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device comprising:
a power source;
a processor capable of being switched between a first mode and a second mode;
an interface module adapted to exchange data with an external device;
a switching module connected between the power source and the interface module;
wherein when the processor is in the first mode, the processor control the switching module to be turned off and the power source stops providing operating voltage to the interface module.

2. The electronic device of claim 1, further comprising a switch, wherein when the switch is turned off, the processor switches to the first mode and provides a first control signal to the switching module; when the switch is turned on, the processor is in a second mode and provides a second control signal to the switching module.

3. The electronic device of claim 2, wherein one end of the switch is connected to the processor, the other end of the switch is grounded.

4. The electronic device of claim 2, further comprising an optical pickup head, wherein when the switch is turned off, the processor further generates a driving signal to the optical pickup head, the optical pickup head start emitting laser beams in response to the driving signal.

5. The electronic device of claim 2, wherein the switching module comprises a first transistor, a resistance, and a second transistor, a base of the first transistor is connected to the processor, an emitter of the first transistor is grounded, a collector of the first transistor is connected to the power source through the resistance, a gate of the second transistor is connected to the collector of the first transistor, a source of the second transistor is connected to the power source, a drain of the second transistor is connected to the interface module.

6. The electronic device of claim 5, wherein the first transistor is an NPN type bipolar junction transistor, the second transistor is a p-channel enhancement type metal oxide semiconductor field effect transistor.

7. The electronic device of claim 5, further comprising a protecting module, wherein the protecting module is connected between the switching module and the interface module, the protecting module is used for determined whether a current flowing through the protecting module is at least a predetermined value, when the current is at least the predetermined value, the protecting module cuts off an electrical connection between the switching module and the interface module; when the current is less than the predetermined value, the protecting module establishes the electrical connection between the switching module and the interface module.

8. The electronic device of claim 7, wherein the predetermined value is 500 mA.

9. A switching circuit connected to a power source and an interface module, the interface module being used for exchanging data with an external device, the switching circuit comprising:
a processor capable of being switched between a first mode and a second mode; and
a switching module connected between the power source and the interface module;
wherein when the processor is in the first mode, the processor controls the switching module to be turned off, and the power source stops providing the operating voltage to the interface module; when the processor is in the second mode, the processor controls the switching module to be turned on, and the power source provides an operating voltage to the interface module.

10. The switch circuit of claim 9, wherein the processor connects with an optical pickup head, when the switch circuit is turned off, the processor further generates a driving signal to the optical pickup head, and the optical pickup head emits laser beams in response to the driving signal.

11. The switching circuit of claim 9, further comprising a switch, wherein when the switch is turned off, the processor switches to the first mode and provides a first control signal to the switching module, when the switch is turned on, the processor switches to the second mode and provides a second control signal to the switching module.

12. The switching circuit of claim 11, wherein one end of the switch is connected to the processor, the other end of the switch is grounded.

13. The switching circuit of claim 11, wherein the first control signal is a low level and the second control signal is a high level.

14. The switch circuit of claim 11, wherein the switching module comprises a first transistor, a resistance, and a second transistor, a base of the first transistor is connected to the processor, an emitter of the first transistor is grounded, a collector of the first transistor is connected to the power source through the resistance, a gate of the second transistor is connected to the collector of the first transistor, a source of the second transistor is connected to the power source, an drain of the second transistor is connected to the interface module.

15. The switch circuit of claim 14, wherein the first transistor is an NPN type bipolar junction transistor and the second transistor is a p-channel enhancement type metal oxide semiconductor field effect transistor.

16. The switching circuit of claim 14, further comprising a protecting module, wherein the protecting module is used for determining whether a current flowing through the protecting module is at least a predetermined value, when the current is at least the predetermined value, the protecting module cuts off an electrical connection between the switching module and the interface module; when the current is less than the predetermined value, the protecting module establishes the electrical connection between the switching module and the interface module.

17. The switching circuit of claim 16, wherein the predetermined value is 500 mA.

18. A video player comprising:
a power source;
a processor capable of being switched between a first mode and a second mode;
an interface module adapted to exchange data with an external device;
a switching module connected between the power source and the interface module;
an optical pickup head connected with the processor adapted to emit laser beams;
wherein when the processor is in the first mode, the processor control the switching module to be turned off and the power source stops providing operating voltage to the interface module and generates a driving signal to the optical pickup head, the optical pickup head emits laser beams in response to the driving signal.

19. The video player of claim 18, wherein when the processor is in the second mode, the processor control the switching module to be turned on and the power source providing operating voltage to the interface module and stop generating driving signal to the OPU.

20. The video player of claim 18, wherein the switching module comprises a first transistor, a resistance, and a second transistor, a base of the first transistor is connected to the processor, an emitter of the first transistor is grounded, a collector of the first transistor is connected to the power source through the resistance, a gate of the second transistor is connected to the collector of the first transistor, a source of the second transistor is connected to the power source, a drain of the second transistor is connected to the interface module.
